(19) United States
(12) Patent Application Publication
(10) Pub. No.: US 2003/0236671 A1
(43) Pub. Date: Dec. 25, 2003

(54) System and method of loadable languages for implement monitoring display

(75) Inventors: Wayne A. Andersen, Bettendorf, IA (US); Michael Bajc, Des Moines, IA (US)

Correspondence Address: ZARLEY LAW FIRM P.L.C., CAPITAL SQUARE, 400 LOCUST, SUITE 200, DES MOINES, IA, 50309-2350, US

(73) Assignee: Deere & Company, Moline, IL

(21) Appl. No.: 10/176,279

(22) Filed: Jun. 20, 2002

(51) Int. Cl. G10L 11/00

(52) U.S. Cl. 704/277

(57) ABSTRACT

The present invention discloses a method and system for providing user selectable loadable language blocks to at least one implement monitor and to a display for displaying information from at least one implement monitor, the system includes a first article of software programmed to generate a first language block, a second article of software programmed to facilitate, translation of the first language block to a second language block, and a set of instructions contained within the language server to transfer at least one of the language blocks to the at least one implement monitor.

### BACKGROUND OF THE INVENTION

1) Field of the Invention

The invention relates to implement monitoring and display. More particularly, the invention relates to a system and method of loading and distributing language blocks so that a single implement monitoring system is readily configurable for displaying information in different formats and languages.

2) Related Art

One example of an implement monitoring and display system is the Green Star Display (GSD) available from John Deere. The GSD is an electronic module with a general purpose display and general purpose key pad that can be used to display tractor and/or implement information. Its primary purpose is to provide a display head for various implement monitors. Such implement monitors may be used on combines, tractors, self-propelled sprayers, utility vehicles, and other implements or equipment. Implement monitors can be used for implement performance information, GPS information, yield monitoring, and other purposes.

A single display unit may be used with multiple implement monitors. Despite the advantages of such a system, problems remain. In particular, there are problems in adapting such a system to be used for different languages. In such a system, there are many problems in developing an interface suitable to be used with multiple languages. It is desirable to make a single implement monitor display system that can be easily adapted to support multiple languages. Further, it is desirable to manufacture implement monitors that can be adapted to multiple foreign languages. There are numerous problems in creating such a system.

One prior art solution would be to use a system that provides built-in support for a limited number of languages. For example, such a system could support common languages such as English, Spanish, German, and French. Such a prior art system is embodied in the Green Star product available from John Deere. Such an implementation is limited to a fixed list of foreign languages. Problems include a lack of support for these languages. For example, support can be a problem because new product versions cannot be released until all four translations are complete. Engineers and software developers are not typically translation experts. Therefore, engineering would need to communicate with outside translators in order to provide support.

A further problem is that the process of adapting a software system for different languages involves more than merely substituting text strings. The whole screen format or user interface may need to be altered because of space requirements. Text strings in one language may be longer or shorter than an equivalent in a different language. Thus, problems remain.

Therefore, it is a primary object of the present invention to improve upon the state of the art.

It is a further object of the present invention to provide an implement monitoring display system that is capable of supporting more than four languages.

It is a still further object of the present invention to provide an implement monitoring system that facilitates translations from one language into other languages.

Yet another object of the present invention is to provide a method and system for providing an implement monitoring display system that reduces the amount of time and resources needed to be devoted to communication between foreign language translation experts and engineering staff.

A further object of the present invention is to provide an implement monitoring system wherein languages can be easily updated.

A still further object of the present invention is to provide an implement monitoring system that can be easily adapted to any foreign language.

Another object of the present invention is to provide an implement monitoring display system that can be adapted for use with multiple foreign languages without requiring revision of the source code.

Yet another object of the present invention is to provide for an implement monitoring system that provides for user selectable loadable language blocks.

A still further object of the present invention is to provide an implement monitoring system that allows language blocks loaded on a language server to be communicated to multiple implement monitors.

These and other objects of the present invention will become apparent from the specification and claims.

### BRIEF SUMMARY OF THE INVENTION

The present invention includes a system and method for providing user selectable loadable language blocks to at least one implement monitor and to a display. An implement monitor is a language server in communication with a display. The display provides for displaying information from the at least one implement monitor. The language server is electrically connected to the display and a bus connects the language server and at least one implement monitor. The system further provides for the creation of user selectable loadable language blocks. The system includes a first article of software programmed to generate a first language block, a second article of software programmed to facilitate translation of the first language block to a second language block, and a set of instructions contained within the language server to transfer at least one of the language blocks to at least one implement monitor.

The present invention provides the advantages of an implement monitoring system that is capable of being adapted to support any number of foreign languages. The translation between languages is facilitated through software. The software allows not only translation, but also provides for altering the user interface or the display format in order to accommodate different languages. This includes changing object types of display objects, changing selection types, changing title types, in addition to merely translating the words to ensure that the display format or interface is suitable for use in different languages.

A language block, once created, can be loaded onto a language server within the implement monitoring display system. Once the language block is loaded, the language block can be transferred from the language server associated with a display to other implement monitors interconnected on the same bus. In this manner, the present invention provides for the advantage of being able to allow an implement monitoring system to support multiple foreign languages. The software is easily updateable to accommodate new foreign languages or other software updates.

According to the method of the present invention, a first language block is generated which contains text of a first language to be visually displayed to provide visual feedback of an implement monitor. Once the first language block is generated, the first language block is translated into a second language block containing text of a second language to be visually displayed to provide visual feedback of the implement monitor. Then a language server electrically connected to the display is loaded with the second language block. Next, the second language block is transferred from the language server to an implement monitor. Visual feedback of the implement monitor is then displayed according to the second language block. Thus, according to the method of the present invention, a language block can be created, loaded onto a language server of the display system, transferred to an implement monitor, and used to display visual feedback of the implement monitor.

The implement monitoring display system of the present invention provides for displaying information from at least one implement monitor. The implement monitor display system includes a display for displaying information, a language server electrically connected to the display, a bus electrically connected to the implement monitor and the language server, a plurality of language blocks accessible to the language server, a user input operatively connected to the language server for receiving a user selection of at least one of a plurality of language blocks, and the language server being programmed to transfer at least one of the plurality of language blocks to at least one implement monitor.

This invention also contemplates that the information to be translated is sent by available modes to remote international locations where translated language can be easily read and understood. This shifts the responsibility of translating the information to personnel located in the regions of the world where the translation will be utilized.

### BRIEF DESCRIPTION OF THE DRAWINGS

FIG. 1 is a block diagram showing the implement monitoring display system of the present invention.

FIG. 2 is a front view of an implement monitoring display of the present invention.

FIG. 3 is a flow diagram showing one methodology according to the present invention.

FIGS. 4A through 4G are pictorial representations of user interfaces of the present invention that illustrate how the screen format or user interface may be modified to accommodate different languages.

### DETAILED DESCRIPTION OF THE INVENTION

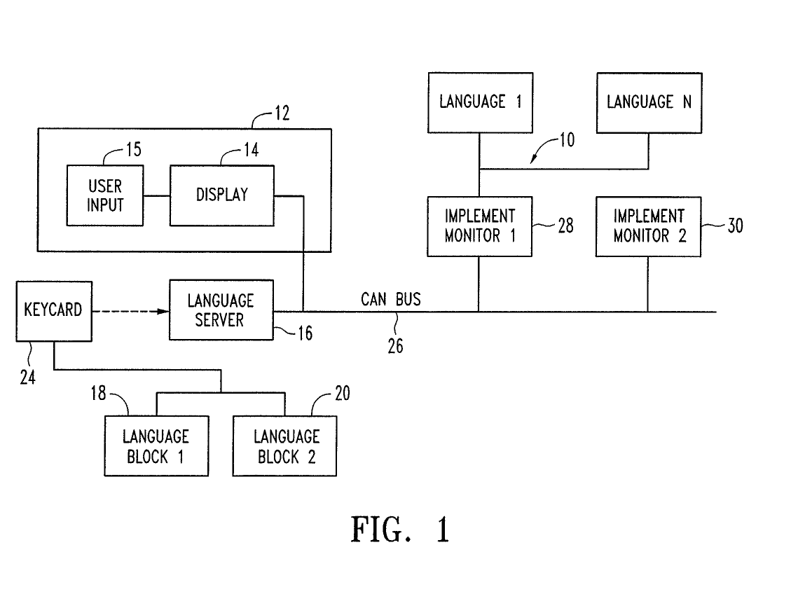

The invention provides for a system and method for implement monitoring that provides for support for multiple languages. As shown in FIG. 1, the implement monitoring system 10 includes an implement monitoring display 12. The implement monitoring display 12 is a unit that includes a display 14 electrically connected to a language server 16. In addition, user input 15 is electrically connected to the language server 16. Loaded on or otherwise accessible to the language server 16 are a plurality of language blocks such as a first language block 18 and a second language block 20. A removable module such as a Key Card™ 24 is optionally electrically connected to the language server 16. Additional language blocks are contained on the removable module 24 in order to be loaded onto the language server 16. The language server 16 is also electrically connected to a bus 26. The bus 26 may be a Controller Area Network (CAN) bus or other bus or interconnection such as is known in the art. Also connected to the bus 26 is at least one implement monitor. Implement monitors include monitors such as may be used to sense or monitor engine performance or vehicle performance. In addition, the implement monitors may be associated with more specific monitoring tasks. For example, where used in conjunction with agricultural implements, the implement monitors may be used to monitor yield, or otherwise monitor the harvesting process, monitor the planting process, monitor the application of chemicals, or other processes. As shown, a first implement monitor 28 and a second implement monitor 30 are electrically connected to bus 26.

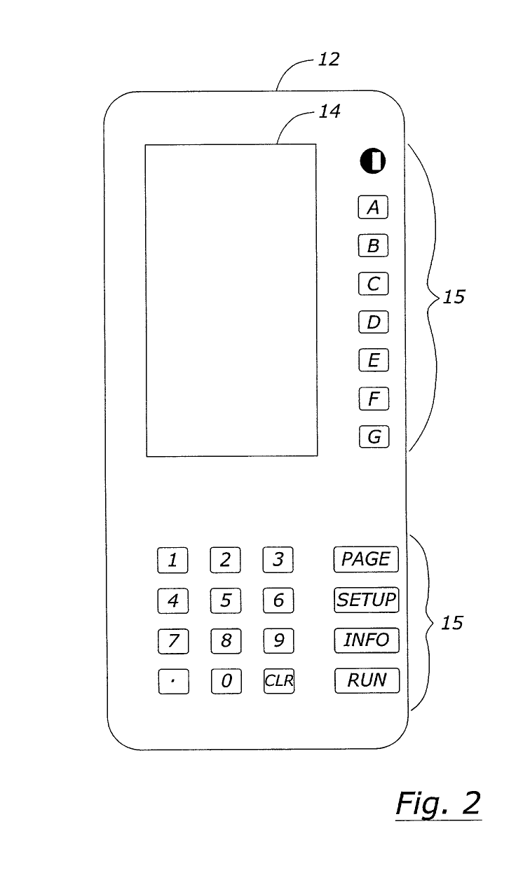

FIG. 2 provides a front view of the implement monitoring display system 12 of the present invention. In FIG. 2, the implement monitoring display system 12 includes a display 14, and a plurality of user inputs 15. Although not shown in FIG. 2, the input monitoring display system 12 also includes a language server electrically connected to the display 14 and to the user inputs 15. In addition, the implement monitoring display system is preferably adapted to receive a removable device such as a Key Card™ that contains additional language blocks.

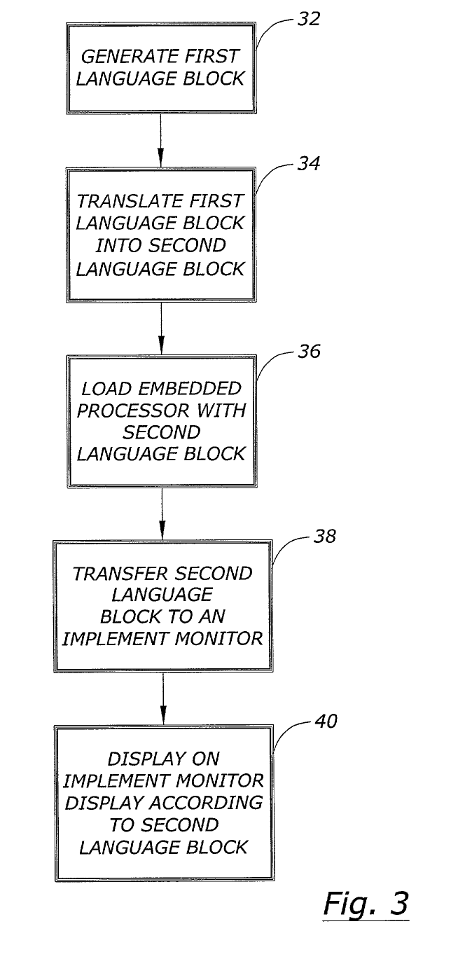

FIG. 3 is a flow diagram of one method according to the present invention. In step 32 of FIG. 3, a first language block is generated. The first language block may be in the English language, although the present invention contemplates the first language block may be in any language. Preferably, the first language block is in a language that the engineers and/or software developers are fluent in. In step 34, the language block is translated to create a second language block. In addition to merely translating words, the present invention provides for altering the display format or user interface associated with the first language block to create a second display format or user interface associated with the second language block. For example, in the translation process, a single English word may not translate precisely to a single German word. Furthermore, the English word may be longer or shorter than the German word. The present invention removes restrictions that previously limited the ability to create proper translations. Alternate display formats may be used. For example, the present invention contemplates that object types may be changed. In addition, the present invention contemplates that selection types may be changed, as well as title types. These different types are merely ways of describing the user interface or the display format and the elements or objects that are a part of the user interface or display format.

Next, in step 36, the second language block is loaded onto a language server within the implement monitoring display system. The present invention contemplates that the language block may be loaded in any way. For example, the language block may be loaded into the language server from a Key Card™ or other removable module as well as any other memory.

Next, in step 38, the second language block is transferred to at least one implement monitor. Where the language server is electrically connected on the bus to one or more implement monitors, the language block is transferred across the bus from the language server to the implement monitor.

Next, in step 40, the information from the implement monitor is displayed on the implement monitor display according to the second language block. This includes displaying text in the proper language and selecting proper object types, title types, selection types and/or other properties associated with the display format.

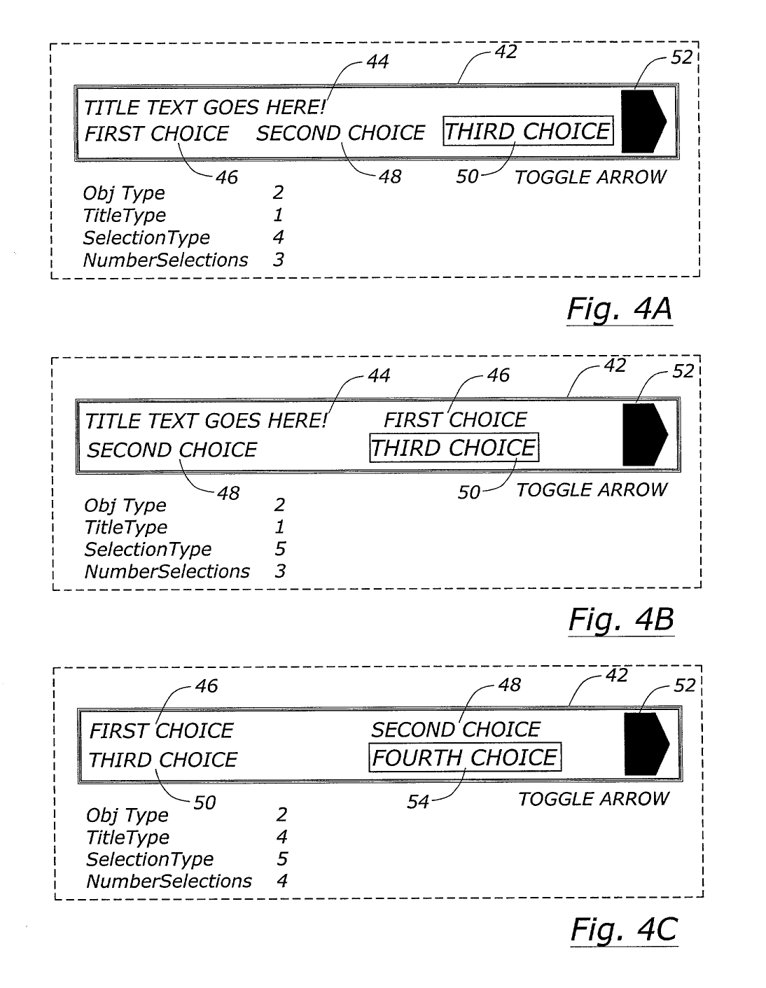

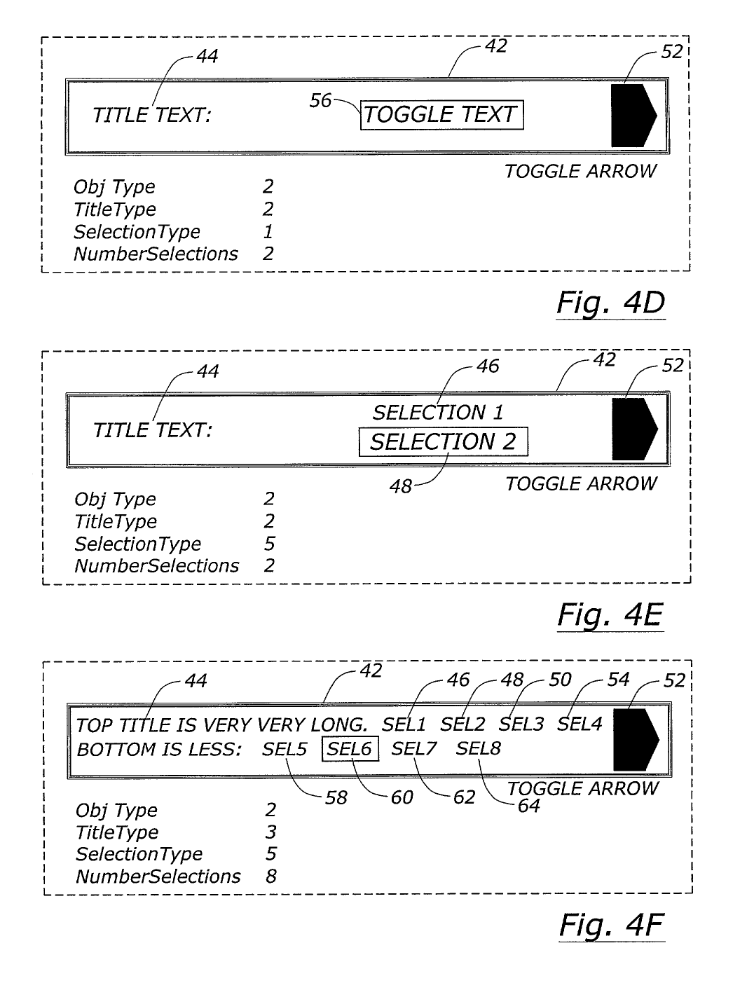

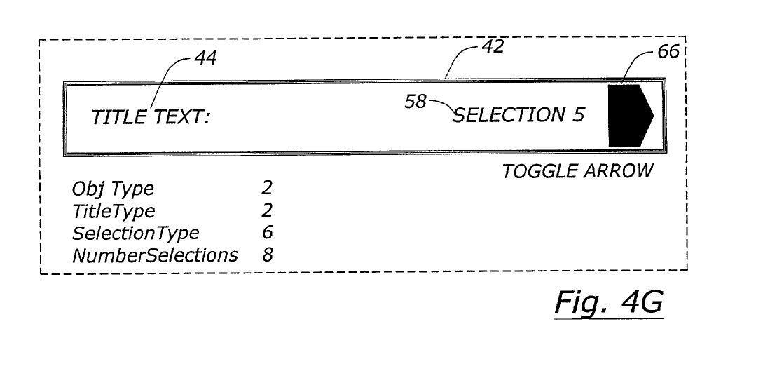

The adaptation of the screen format or user interface supports the translation process. FIGS. 4A through 4G illustrate representative manners in which the screen display or user interface may be altered in the creation of a new language block. It should be appreciated that these alterations are made without requiring reprogramming. Further, the present invention contemplates any number of properties associated with the screen format or user interface to be altered.

Where the first language block is created in English, an English language file generator is used to create a file that contains all the English text as used by the application. The English language file generator records in the file information as required by translators. After this function is performed, an English language block translator tool is then used to facilitate the translation of the English text of other languages. The translator can now establish language objects to translate groups of related text. This allows the translators to rearrange wording to accommodate the foreign text that is of a different length than the English text or of a different syntax. This results in a shifting of the translation responsibility from engineers to the translator.

In FIG. 4A, a screen display or format 42 is shown. The screen display includes title text 44 as well as three different selections, a first selection 46, a second selection 48, and a third selection 50. The third selection 50 is selected. In addition, a toggle arrow 52 is shown that allows a user to toggle between different selections. The present invention provides for different variations on the objects used, the titles used, and the selections used. The object type to be used, the title type to be used, and the selection type to be used depend at least partially upon the amount or size of translated text.

Another example of a screen format or user interface is shown in FIG. 4B. The screen 42 includes title text 44 as well as three selections, the first selection 46, a second selection 48 and a third selection 50. FIG. 4A and FIG. 4B differ according to the selection type chosen. The selection type chosen in FIG. 4B allows the first selection 46 to be placed upon the same line as the title text 44. This selection type accommodates the situation that arises when the first selection 46, the second selection 48, and the third selection 50 are too lengthy to fit on a single line—such as that shown in FIG. 4A.

FIG. 4C provides yet another illustration of how the screen display format can be altered in order to support the translation of language blocks into different languages. According to FIG. 4C, there are four selections which include a first selection 46, a second selection 48, a third selection 50, and a fourth selection 54. The title is not shown in FIG. 4C in order to make room for all of the available selections.

Another example is shown in FIG. 4D. In FIG. 4D a centered title 44 is shown and there are two selections available although only one selection is displayed at once. The selection 56 may be toggled between two or more values. Another example of a screen format is shown in FIG. 4E. In FIG. 4E, the title 44 is centered and there are two selections available, the sections being on different lines.

As shown in FIG. 4F, there are eight selections available and the title 44 has two lines with the top title line being longer than the bottom title line.

In FIG. 4G, the title 44 is centered and there are eight selections. Different selections (may be chosen by using a “go to” arrow 66 to change between the selections.

The present invention contemplates that the display format may be altered in these and other ways in order to accommodate proper foreign language translations. The object type, title type, selection type, and other visual properties of the display format are selected according to the amount of space available after the text has been translated and other considerations that may be proper given a particular translation. The selection of the proper display format is either automatically determined by the software or is selected by a user.

Therefore the present invention provides a system and method for providing user selectable loadable language blocks to implement monitors and an implement monitoring display system. The invention provides for altering language blocks to accommodate various foreign languages. The invention does so without requiring engineers to be involved in the translation process.

It should be appreciated that the present invention contemplates any number of languages to be used, any language to be used, different screen display formats or interfaces, different types of optional removable modules for containing language blocks, any number of types of implement monitors, and other variations.

As previously indicated the method wherein the visual feedback is transmitted to remote international locations where translated language can be easily read and understood so as to shift the responsibility of dealing with the translated information from local areas to support appropriate and relevant operation in different regions of the world.

What is claimed is:

1. A system for providing user selectable loadable language blocks to at least one implement monitor and a display for displaying information from at least one implement monitor, a language server electrically connected to the display, and at least one implement monitor comprising:
a first article of software programmed to generate a first language block;
a second article of software programmed to facilitate translation of the first block to a second language block; and
a language server to transfer at least one of the language blocks to at least one implement monitor.

2. The system of claim 1 wherein the second article of software is programmed to facilitate translation of the first language block to a second language block by allowing a user to alter a display format used for displaying information.

3. The system of claim 2 wherein the display format includes an object type to allow alteration of the text and the method by which it is presented.

4. A method for providing an implement monitoring display system, comprising:
generating a first language block containing text of a first language to be visually displayed to provide visual feedback of an implement monitor;
translating the first language block into a second language block containing text of a second language to be visually displayed to provide visual feedback of the implement monitor;
transferring a second language block to a language server;
transferring the second language block from the language server to an implement monitor; and
displaying visual feedback of the implement monitor according to the second block.

5. The method of claim 4 further comprising altering a first display format associated with the first language block to create a second display format associated with the second language block.

6. The method of claim 5 wherein the step of altering includes changing an object type to allow alteration of the text and the method by which it is presented.

7. An implement monitoring display system for displaying information from at least one implement monitor, comprising:
a display for displaying information;
a language server electrically connected to the display;
an implement monitor electrically connected to the language server and the display;
a plurality of language blocks accessible to the language server;
a user input operatively connected to the language server for receiving a user selection of at least one of the plurality of language blocks; and
the language server being programmed to transfer at least one of the plurality of language blocks to at least one implement monitor.

8. The implement monitoring display system of claim 7 wherein each of the plurality of language blocks include a display format representation.

9. The implement monitoring display system of claim 8; wherein the display format representation includes an object type to allow alteration of the text and the method by which it is presented.

10. The implement monitoring display system of claim 7 further comprising a removable module operatively connected to the language server, the removable module containing at least one of the plurality of language blocks.

11. The method of claim 4 wherein the visual feedback is transmitted to remote international locations where translated language can be easily read and understood so as to shift the responsibility of dealing with the translated information to personnel located in the regions of the world where the translation will be utilized.
